(19) United States
(12) Patent Application Publication
(10) Pub. No.: US 2008/0217551 A1
(43) Pub. Date: Sep. 11, 2008

(54) REAL TIME RADIATION MONITORING SYSTEM AND PORTABLE TELEPOSITIONAL RADIATION DOSIMETER

(76) Inventors: Chong ZHANG, Beijing (CN); Xiangiun XU, Beijing (CN)

Correspondence Address: SAWYER LAW GROUP LLP, 2465 E. Bayshore Road, Suite No. 406, PALO ALTO, CA, 94303, US

(21) Appl. No.: 11/683,966

(22) Filed: Mar. 8, 2007

(51) Int. Cl. G01T 1/02

(52) U.S. Cl. 250/390.03; 250/336.1; 340/870.02

(57) ABSTRACT

The present invention provides a system, device, computer program product and article for a telepositional dosimeter (TPD) and a radiation measurement system (RMS) having one or more TPDs capable of communicating environmental radiation measurements to a network, database or other data management technology. The present invention combines radiation measurement technology, wireless network and mobile communication technology, software, and related technologies to enable applications in various environments including the areas of environmental protection, homeland security, anti-terrorism, nuclear safety, radiation material handling and safety, and emergency response.

### FIELD OF THE INVENTION

The present embodiment relates generally to radiation detection and dosimetry and more particularly to a real time radiation monitoring device and system integrating a portable telepositional dosimeter.

### BACKGROUND OF THE INVENTION

Monitoring radiation exposure from ionizing radiation is of heightened importance in a variety of areas such as homeland security, environmental protection, nuclear safety, general emergency response and preparedness, and instrumentation and testing. In general, both passive and active dosimeters have been used to detect radiation and thereafter report a finding in a delayed (i.e., passive) or immediate (i.e., active) response period. The two different dosimeter reporting technologies each have certain advantages and limitations.

For example, certain passive dosimeters may employ thermoluminescence (TLD) technology to meet strict performance requirements of governmental requirements but TLD-based dosimeters are unable to provide immediate reporting of any findings. Certain active dosimeters may be deployed in routine environments to provide an immediate report warning where radiation exposure exceeds a predetermined range or level, however often these active dosimeters can be errorful and imprecise. In general, dosimeters, be they passive or active often have further limitations.

Dosimeters, when handheld, may be ideally suited for early or pre-emergency targeted identification due to their portable features, but typically these dosimeters are limited in their ability to communicate and report their respective results to interested users apart from a user holding the handheld device. Additionally, a handheld dosimeter often only provides radiation measurement, limited alarm functions in response to radiation measurements, and other limited functionality usually also related to only radiation detection.

Further, handheld dosimeters lack network connectivity, positional and proximity detection, likely as they are intended for stand alone use in the field in an area requiring measurement or detection. Unfortunately users of dosimeters have heretofore been required to independently take a dosimeter's measurement results of a target and separately apply the results to other data systems, users, and third parties who may have an interest in the results collected. Interested users who are not proximate to the handheld dosimeters often find delays in information receipt, timeliness of data results, and errors in transcription of data.

Attempts to create systems deploying dosimeters have also presented limitations in portability and communication. Typically, systems deploying mobile dosimeter-based devices have required base stations and large physical equipment to be present with each sensor device. Often the “mobility” aspect proposed in these systems has been disappointing and does not permit a single user to easily use or access a device in such a system, to readily obtain key positional or geospatial information about the device or area of coverage, nor have such systems provided a simple deployment option to a user in the field. Additionally, these attempts to create integrated mobile systems have often resulted in complex infrastructure and sizeable expense. Unfortunately, many of these attempted integrated mobile systems are not only unable to quickly respond or even reach a target position, particularly where there is an emergency response needed, but they are unable to instantly and comprehensively collect radiation measurements as instantaneous, cumulative and time-distributed data events, or in relation to geographical location.

Accordingly, what is desired is a system and device to overcome the limitations of the present art and provide a portable telepositonal dosimeter with added functionality over existing dosimeters. Additionally, what is desired is a system and device for a radiation monitoring system including one or more telepositional dosimeters capable of timely measuring and reporting environmental radiation measurements, instantaneously, cumulatively and as time-distributed data events, with relation to geographical location, as well as other environmental data, to a network or network system. The present invention addresses such a need.

### SUMMARY OF THE INVENTION

The present invention fulfills these needs and has been developed in response to the present state of the art, and in particular, in response to the problems and needs in the art that have not yet been fully solved by currently available dosimeters, radiation measurement systems and related technologies.

The present invention sets forth a system, device, computer program product and article for a telepositional dosimeter (TPD) and a radiation measurement system (RMS) having one or more TPDs capable of communicating environmental radiation measurements to a network, database or other data management technology. The present invention combines radiation measurement technology, wireless network and mobile communication technology, software, and related technologies to enable applications in various environments including the areas of environmental protection, homeland security, anti-terrorism, nuclear safety, radiation material handling and safety, and emergency response. The present invention can be operated, displayed, updated and deployed locally or remotely, use in various networks, and is capable of collecting, transmitting and receiving position, time, historical data and other information in a portable dimension.

The present invention provides for a portable telepositional dosimeter (TPD) and a real time radiation monitoring system (RMS) having one or more TPDs in communication. The TPDs of the present invention comprise radiation measurement capabilities, wireless communication means, worldwide positional location information means, geospatial information means, processing means and networking technology means. Additionally, a TPD is portable and of a dimension capable of being held the hand of a user. The TPDs of the present invention further provide display means for providing visual, audio, and sensory information to a user in relation to radiation measurements taken of target locations and other notices from analyzed or received data, as well as communication means for providing network communication with a network system or other device.

An RMS of the present invention includes a software-centric data center having data center software, one or more communication means providing communication linkage between the data center and the one or more TPDs of the system, where the TPDs may display information, results, status, geographic, positional, timing, and other information both locally to a user holding or in proximity to the TPD, as well as remotely to a network or other device in communication with the TPD which may thereafter further analyze received information.

### BRIEF DESCRIPTION OF THE DRAWINGS

FIG. 1 is a pictorial representation of a preferred embodiment of a RMS of the present invention;

FIG. 2 is a functional block diagram of a preferred embodiment of the TPD of the present invention;

FIG. 3A is a functional block diagram of a further preferred embodiment of the TPD of the present invention in a further implementation;

FIG. 3B is a functional block diagram of an operational status mode means of the present invention in a preferred embodiment;

FIG. 4 is a functional block diagram of a preferred embodiment of the data center software (DCSW) of the present invention;

FIG. 5 is a functional pictorial representation of a preferred embodiment of a RMS of the present invention in a preferred implementation;

FIG. 6 is a functional block diagram of a preferred embodiment of the gateway of the present invention in a preferred implementation; and,

FIG. 7 is a block diagram of the creation of a complete data set under the present invention in a preferred embodiment.

### DETAILED DESCRIPTION

The present invention relates generally to radiation detection and dosimetry and more particularly to a real time radiation monitoring device, system, computer product and article integrating one or more portable telepositional dosimeters. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

In one embodiment of the present invention, a telepositional dosimeter device for measuring radiation comprising an operational mode status, a software means, one or more communication means, a display means, a processing means, a memory means, an input means, a positioning and timing means, a notification means, and a power means, wherein said processing means is controlled by said control logic means and said device is portable, is provided. In another preferred embodiment, the TPD further comprises a local communication means and has operation mode status comprising one or more modes of monitoring, searching security, and timer, wherein each mode further comprises an alarm notification means.

In another embodiment, the present invention is a radiation measurement system for measuring and detecting radiation at one or more target areas comprising one or more software-centric data centers each having data center software, one or more communication means providing communication linkage between a data center and one or more telepositional dosimeters of the system, whereby each TPD further comprises a processing means instructively coupled to one or more software means, one or more communication means, a display means, a processing means, a memory means, an input means, a positioning and timing means, a notification means, a power means, and an operational status means, wherein said radiation includes alpha radiation, beta radiation, gamma radiation, x-ray radiation, neutron emissions, and related dosimetry-types of radiation and particle detection of radiated particles, and said TPD is portable, is provided for.

In another embodiment of the present invention a computer program product is provided where the computer readable program means causes a computer to analyze radiation measurement data from a radiation measurement means of one or more telepositional dosimeters and communicate a complete data set to one or more remote users; the computer program product including program instructions for collecting, analyzing and transmitting data comprising: collecting radiation measurement data, collecting operation mode status data, collecting positioning and timing data, combining collected data, storing combined collected data, and transmitting stored combined collected data as a complete data set to one or more remote users.

In a further preferred embodiment, a portable TPD in communication with one or more remote networked devices through one or more communication pathways, wherein said TPD provides a complete data set of information across said one or more communication pathways to said one or more remote networked devices for collection at a remote networked storage database, wherein said TPD comprises processor-controlled logic means for instructing each coupled therewith including a display, a memory, a storage device, an input device, a positioning and timing module, an operational mode status switch, an alarm and TPD software, wherein said operational mode status switch comprises one or more modes of monitoring, searching security, and timer, wherein each mode is operable to activate or deactivate said alarm, is provided for.

As used herein, the term “TPD” of the present invention is intended to be either a networked data collector (NDC), capable in part of radiation measurement and detection, or a standalone personal dosimeter (SPD), each having similar data collection and sensor-based detection capability, each being portable (i.e., handheld, wearable, mobile without assistance of another device, compact, etc.), and where either may be applicable to the term “TPD” and may be used interchangeably herein unless expressly set forth otherwise. Further, the term “TPD” is intended to include a radiation measurement device having an outer case, the dimensions of which are not restrictive except as to be portable to a user, where such a device further comprises software, one or more communication means, a display means, a processing means, a memory and/or storage means, an input means, a positioning and timing means, a notification means, a power means, and optionally, a local communication means.

As used herein the term “radiation” is intended to mean alpha radiation, beta radiation, gamma radiation, x-ray radiation, neutron emissions, and related dosimetry-types of radiation or particle detection capabilities and technologies.

As used herein the term “measurement” is not intended to be restrictive to a particular measure, amount or methodology of gathering a detection or measured result, rather the term is intended to be inclusive of count rate, dose rate, accumulated dose rate, nucleus identification, nucleus dose rate, periods of detection at an instant in time, periods of detections over a range of time, periods of detection over a function of time, emission rate, dosage rate, and any other measure, method of measure, and unit of measure.

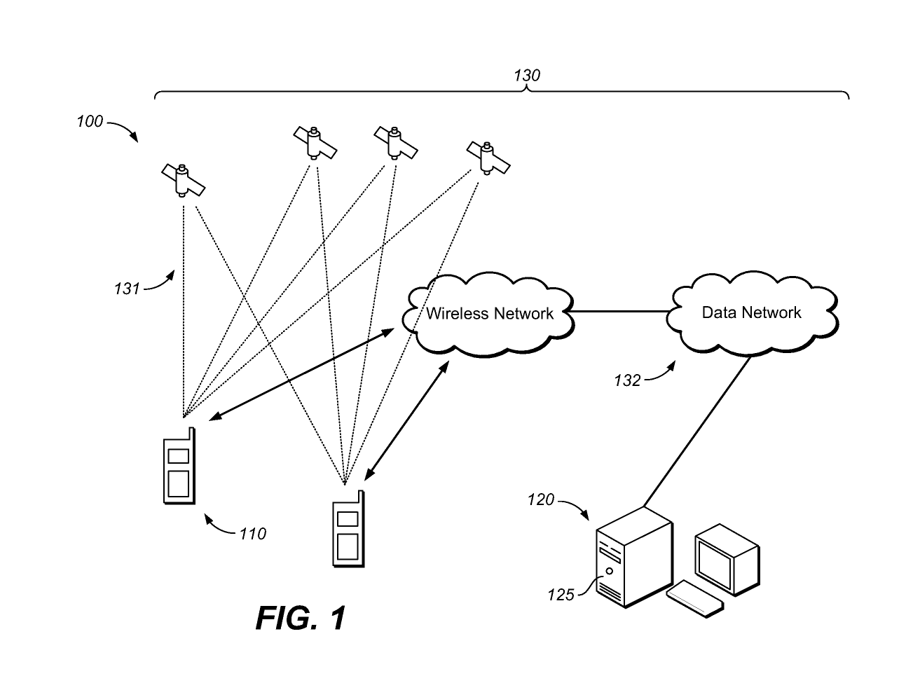

FIG. 1 is a pictorial representation of a preferred embodiment of a RMS 100 of the present invention. In FIG. 1 a RMS 100 includes one or more TPDs 110, a software-centric data center 120 having DCSW 125, and a communication means 130 providing communication linkage between the data center and the one or more TPDs.

The DCSW 125 of the present invention is data management software capable of receiving, collecting, analyzing, storing, transmitting, reporting, exploiting, displaying and extrapolating data, whether collected or generated. The DCSW 125 includes functionality, integrated or modularly resident therein, of that of a management information system (MIS), geographical information system (GIS) and other data management based function.

From FIG. 1, a preferred communication means may include one or more TPDs 110 in or capable of being in communication with a cell or satellite-based telecommunication system 131 (such as but not limited to Global System for Mobile communication/General Packet Radio Systems (GSM/GPRS), Code Division Multiple Access (CDMA), etc.) which is linked to or capable of communication with a data network system 132 (such as but not limited to commercial service provider, private network, internet, etc.) of which the datacenter 120 is linked to or capable of communication with.

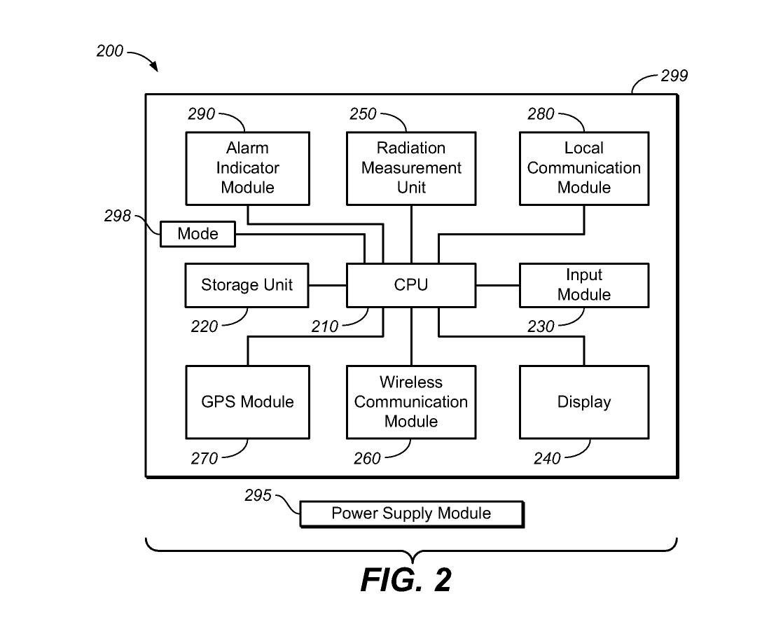

FIG. 2 is a functional block diagram of a preferred embodiment of the TPD 200 of the present invention. From FIG. 2, a TPD 200 includes a processing means 210, a storage means 220, an input means 230, a display means 240, a radiation measurement means 250, a wireless communication means 260, a positioning and timing means 270, a local communication means 280, a notification means 290, a power means 295, and an Operational Mode Status means at 298. A control logic means is also pictorially shown as 299 where the control logic may be a bus, circuitry or other communications means enabling the processing means 210 to instruct and operably control the storage means 220, input means 230, display means 240, radiation measurement means 250, wireless communication means 260, positioning and timing means 270, local communication means 280, notification means 290, power means 295, and Operational Mode Status means at 298, of which the processing means is coupled to one or more of.

The processing means 210 is preferably central to and controls the functions of the TPD logically, which is pictorially represented by the logic means 299 in a preferred embodiment.

The wireless communication means includes one or more of a GSM/GPRS and/or CDMA communication capability and a Transmission Control Protocol/Internet Protocol (TCP/IP), User Datagram Protocol/Internet Protocol (UDP/IP), short message, voice, data and/or other communications protocol.

A radiation measurement means includes the ability and capability to measure or obtain the measurement of radiation as is set forth herein. Preferably, a radiation measurement means is an energy compensation tube based gamma detector, including x-ray.

In a preferred embodiment, a TPD 200 includes a central processing unit 210 instructively coupled by logic means 299 to one or more of a memory and/or drive storage 220, an input device such as a keypad 230, a display integrated in and visible on the TPD 240, a gamma radiation detection sensor 250, a global wireless communication transmitter/receiver 260, a positioning and timing sensor 270, a local communication port 280, an audible, visual, vibration or non-indication alarm 290, and a power supply 295.

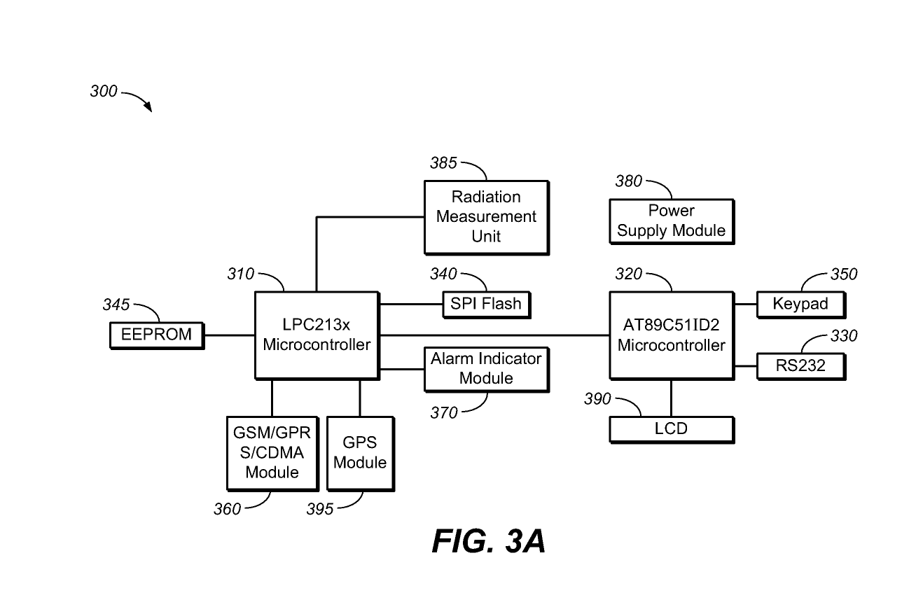

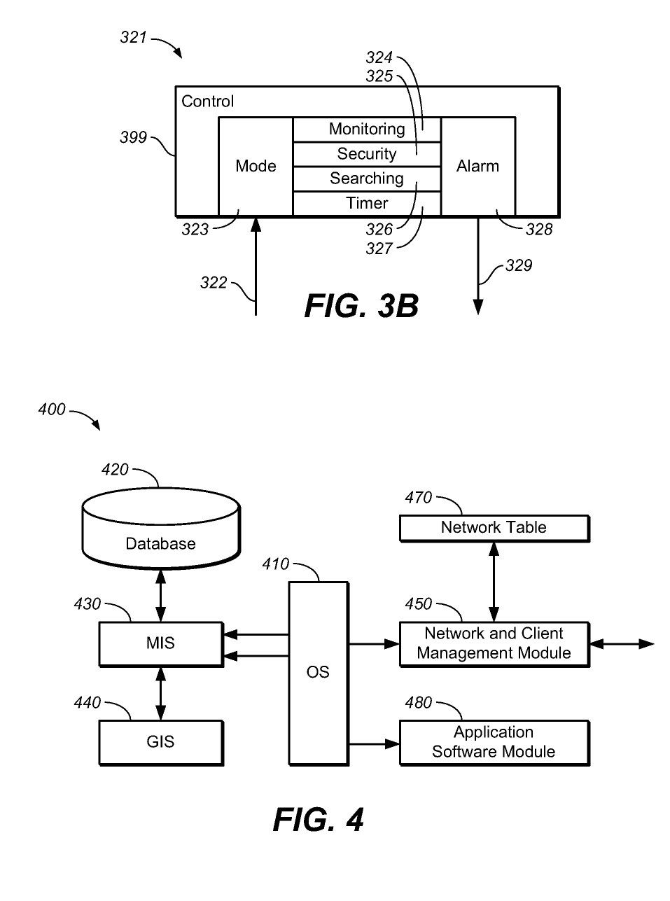

FIG. 3A is a functional block diagram 300 of a further preferred embodiment of the TPD of the present invention in a further implementation, however the present invention is not so limited to only this implementation. In FIG. 3A, the processing means of the TPD consists of two CPUs 310, 320, Philips LP213X and Atmel AT89C511D2. The TPD's local communication means is an RS-232 standard port 330, where a TPD may download all stored data via this or a similar communication port. The TPD's memory and storage means includes an external flash drive 340 and an EEPROM 345, preferably enabling collection of data to exceed ten days. The storage means of the present invention may include generic memory such as flash, EEPROM, SRAM, DRAM, and may be physical or software memory. The TPD's input means, wireless communication means and notification means are, respectively, a keypad 350, a GSM/GPRS or CDMA module 360, and an alarm 370 capable of one or more notification characteristics of audio, visual, and vibration. The power means of the TPD is a power supply module 380 having a high capacity rechargeable battery and associated circuitry. A radiation measurement means 385, display (such as a Liquid Crystal Display (LCD)) 390, and GPS module as part of the positioning means at 395, are also shown.

In operation, in a preferred embodiment, as a gamma ray is detected by the radiation measurement unit, the gamma detector coverts and transmits the detected gamma ray into a set of pulses as input to a processor, such as that of 320. The radiation measurement unit preferably measures more than one type of radiation and in more than one measure or measurement. For instance, in a preferred embodiment, the radiation measurement unit measures one or more of count rate, dose rate, accumulated dose, nucleus identification, nucleus dose rate for one or more radiation types. The processor 320 calculates the gamma dose rate based on the pulses and further determines the accumulated dose or dosage rate. The results are then combined with the positioning and timing information of 360 and 395, as well as the status information of relevant TPDs. The combination of these results and information, though customizable by a user, is determined as a complete data set for a specific event or time. The data analyzed, calculated and combined, including the complete data set, is capable of being stored in the flash 340 as well as being displayed on the display means 390. The stored data is then capable of being communicated remotely based on directions of a user.

The present invention may be operated in one or more operative modes.

FIG. 3B is a functional block diagram 321 of an operational status mode means of the present invention in a preferred embodiment. An operative mode 323 of the present invention is determinable by a user, local or remote, at 322 providing control information, or may be predetermined by presets of a processor or logic means of the TPD at 322. An operational mode at 323 is then defined to be one of a “monitoring mode,” at 324, “security mode,” at 325, “searching mode,” at 326, or “timer mode” at 327. The operative mode 323 of the present invention is determinable locally or remotely at 322, and may be pre-designated, programmed or otherwise pre-determined or defined locally or remotely at 322. A logic means 399 controls the operation of the present invention in a particular mode, as is set forth further below.

In a preferred embodiment, each mode of the operational mode means further comprises an notification means (such as an alarm) at 328 which is operable in relation to preset ranges of a respective mode, where a notification is triggered and communicated in a predetermined manner in response at 329 to said mode and radiation measurement data gathered at a target area. In a further preferred embodiment, an alarm is sent remotely to networked computer or device at 329.

The present invention is operable in a monitoring mode at 324 for radiation measurement and detection. In a monitoring mode, the present invention, via TPDs, monitors real time radiation strength, displays dose rate or accumulated dose rate information on a local display of the TPD or locally networked device, and is capable of transmitting collected data to a data center in communication with one or more TPDs. Additionally, an alarm or notification means can be triggered to activate upon the occurrence of the dose rate and/or the accumulated dose rate exceeding a predetermined threshold or range.

The present invention is operable in a security mode at 325 for radiation material handling and security. In a security mode, the present invention, via TPDs, monitors real time radiation strength, displays dose rate, and provides data to a networked data center. Additionally, an alarm or notification means can be triggered to activate upon the occurrence of the dose rate and/or other rate information falling below a predetermined threshold or range indicating that material may be lost.

The present invention is operable in a searching mode at 326 for radiation material searching and detection. In a searching mode, the present invention, via TPDs, monitors radiation strength in real time and displays locally the strength changes over a predetermined period or range of time. A user is thereby able to determine and find the radiation material in relation to trend changes or similar analysis of the radiation strength information as a function of time. The collected data as a function of time is also provided to a data center in communication with the one or more TPDs. Additionally, an alarm or notification means can be triggered to activate upon the occurrence of the dose rate and/or the accumulated dose rate exceeding a predetermined threshold or range.

The present invention is operable in a timer mode at 327 for personal health of users at or near a target area. In a timer mode, the present invention, via TPDs, is operable by a user when entering a target area. One or more users use their respective TPDs to measure dose rate, accumulated dose rate, and timing in a target area. Additionally, an alarm or notification means can be triggered to activate upon the occurrence of the dose rate, timing and/or other rate information exceeding a predetermined threshold or range indicating that the user has exceeded the safe period in the target area or that measurements exceed safe rates.

The alarm or notification means can be visual, audible, or sensory-based such as vibration. The alarm or notification means can be set by a user of a TPD or remotely by a networked user. In each mode, when an alarm or notification means is triggered and there is remotely connected user or data center, the TPD will activate all preset indicators and immediately transmit collected data to the connected user or data center.

FIG. 4 is a functional block diagram 400 a preferred embodiment of the data center software (DCSW) of the present invention. From FIG. 4, the DCSW includes an operating system means 410, a database means 420, an information management means 430, a geospatial information management means 440, a network and client management means 450, a network table means 470, and application means 480.

In a preferred embodiment, the DCSW includes a Microsoft Windows-based operating system 410; a database 420 of radiation, alarm and sensor-centric values, ranges and characteristics, as well as collected and historic data; MIS software 430; GIS software 440 for presenting collected data or information from the database onto the display, preferably in a map visual; a network management and client management module 450, capable of communication with TPDs in a RMS, which collects data, verifies data collected, and populates the database with verified data; a RMS 470 managed by one or both of the network management module and the client management module, for maintaining the present characteristics of the network and its composition, including its status; and an application module 480 being an expandable functional block where software applications or routines (such as data analysis, report generation, user interfaces, user management, internet and web-based access controls, alarm notifications, etc.) are included in relation to a user's needs for the TPD. The network table maintains the latest collected information of the RMS and its components, including the status and mode setting.

Preferably, the network and client management means manages and communicates with all TPDs in communication with the RMS or a specific user. The network and client management means also collects and verifies all transmitted data, provides the data to the database, and is capable of managing the RMS network. The network and client management means also manages the network table.

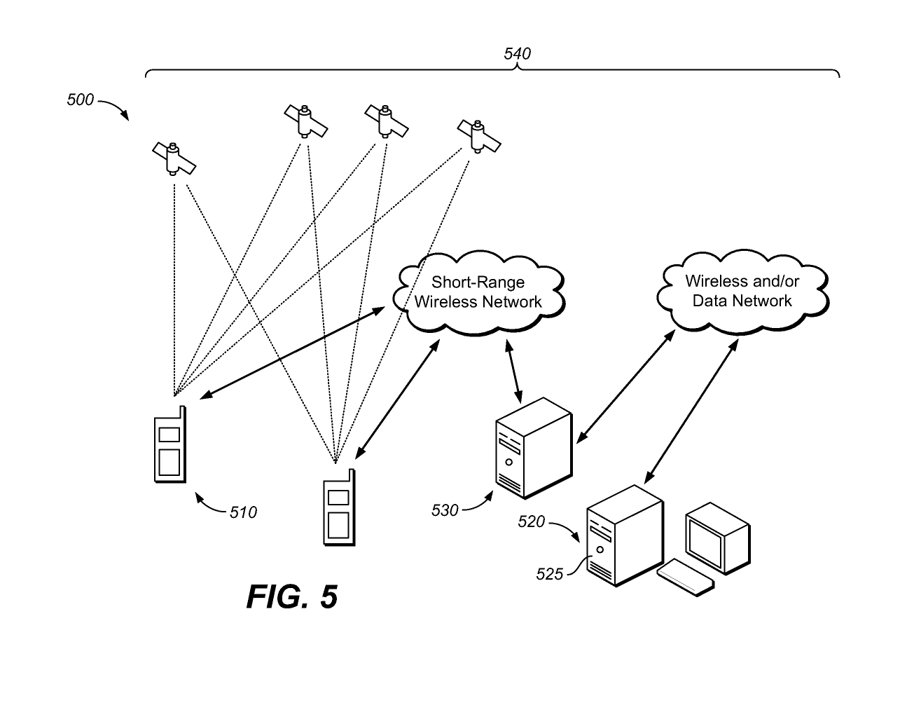

FIG. 5 is a functional pictorial representation of a preferred embodiment of a RMS 500 of the present invention in a preferred implementation. From FIG. 5, the RMS 500 includes one or more short-ranged TPDs 510, a software-centric data center 520 having DCSW 525, and a communication gateway means 530 providing communication linkage between the data center and the one or more TPDs via the communication means 540. The short-ranged TPDs include short-range wireless communication capabilities such as those offered by Bluetooth, ZigBee, infrared, IEEE802.11x/Wi-Fi, IEEE802.15.x, wireless RS-232, wireless Universal Serial Bus (USB), Ultra Wide Band (UWB), etc. The short-ranged TPDs are capable of communication with the gateway and the gateway accesses the network via the network communication module in one of a wired or wireless manner.

In a preferred embodiment, the gateway accesses the data center via a wired communication path including one of, but not limited to, leased line, ethernet, xDSL, cable modem, power line, dial up, fiber optic, etc.

In another preferred embodiment, the gateway accesses the data center via a wireless communication path including one of, but not limited to, radiofrequency (RF), microwave, infrared, satellite, WiMax, Wi-Fi, mobile wireless technologies (e.g., GSM/GPRS, CDMA, 3G, etc.).

As used herein, the gateway may be one or more networks accessible by one or more personal computers (PCs), and the gateway may also be one of a modified network access device having one or more short-ranged wireless communication capabilities as set forth above.

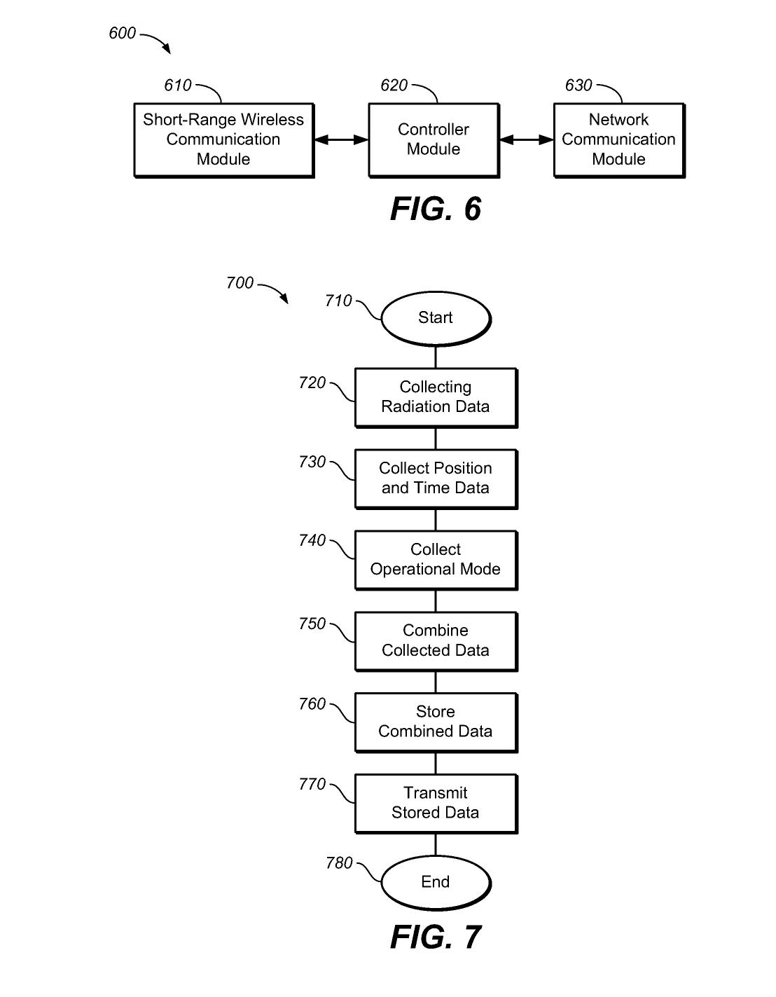

FIG. 6 is a functional block diagram 600 of a preferred embodiment of the gateway of the present invention in a preferred implementation. From FIG. 6, the gateway 600 includes a short-ranged wireless module 610, a controller module 620, and a network communication module 630.

FIG. 7 is a block diagram 700 of the creation of a complete data set under the present invention in a preferred embodiment. From FIG. 7, the steps to create and transmit a complete data set 700 include a computer program readable means for causing a computer to analyze radiation measurement data from a radiation measurement means of one or more telepositional dosimeters and communicate a complete data set to one or more remote users. The steps may include a combination of hardware and software and may be logical or functional based.

Preferably, a computer program product including program instructions beginning at 710 is provided for collecting, analyzing and transmitting data comprising: collecting radiation measurement data at 720, collecting operation mode status data at 730, collecting positioning and timing data at 740, combining collected data at 750, storing combined collected data at 760, and transmitting stored combined collected data as a complete data set to one or more remote users at 770.

In operation, a TPD of the present invention collects information from its target location, including the measurement of radiation, combines the collected data with the timing and positioning information obtained from a known timing and positioning source such as GPS, and creates an data set of collected data and its referentially related timing and positioning information. The data collected may be collected continuously, at predetermined intervals, or at times designated by a local user or a remote user, via the RMS. The data collected and the data set, separately or together, are displayable locally on the TPD, continuously, or at times designated by a local user or a remote user, where such data or data set may also be transmitted to a remote location such as the data center. Data collected in this manner with referential position and/or timing information may be referred to herein as a “complete data set.”

Accordingly, the present invention sets forth a method to overcome the limitations of the present art and be able to create a value object for data that is requested a first time and then use that created value object for subsequent requests of similar data in associated result sets.

As used herein the term “portable” is defined to mean any of being able to be carried or moved with ease, having portability, being mobile or capable of being mobile, movable or capable of being moved from one location to another without complication or motor, handheld, wearable, mobile without assistance of another device, compact, etc and/or having a dimension, weight and physical structure of a portable aspect.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A telepositional dosimeter device for measuring radiation comprising an operational mode status, a software means, one or more communication means, a display means, a processing means, a memory means, an input means, a positioning and timing means, a notification means, a control logic means, and a power means, wherein said processing means is controlled by said control logic means and said device is portable.

2. The device of claim 1, further comprising a local communication means.

3. The device of claim 1, wherein said radiation includes alpha radiation, beta radiation, gamma radiation, x-ray radiation, neutron emissions, and related dosimetry-types of radiation and particle detection of radiated particles.

4. The device of claim 3, wherein said operation mode status comprises one or more modes of monitoring, searching, security, and timer, wherein each mode further comprises an alarm notification means, and said processing means comprises said logic means and is instructively coupled to one or more of said software means, said one or more communication means, said display means, said operational mode means, said memory means, said input means, said positioning and timing means, said local communication means and said notification means.

5. The device of claim 4, wherein said communication means includes one or more wireless communication technologies capable of communication in real time, continuously, intermittently or in a predetermined manner.

6. The device of claim 5, wherein said display means is a display, said processing means includes one or more processing units, said memory means is one or more storage devices, said input means is a keypad, said positioning and timing means is a GPS module, and said power means is a power supply.

7. The device of claim 5, wherein said display means is a display screen, said processing means includes at least one central processing unit controlling communications of said device, said memory means is software-based, and said positioning and timing means is an active GPS module.

8. The device of claim 7, wherein said wireless communication is in one of TCP/IP, UDP/IP across a GSM.GPRS or CDMA based network.

9. The device of claim 7, wherein said alarm notification means include notification from said device by one or more of visual, audio, vibration technology, or non-indication.

10. The device of claim 9, wherein said alarm notification further includes communication of notification to a remotely connected user or device.

11. The device of claim 4, wherein said device is connected to a remote user.

12. The device of claim 11, wherein said user is a remotely connected device having a data storage means, a processing means and display means.

13. The device of claim 12, wherein said remotely connected device is a computer.

14. The device of claim 4, wherein said device is connected to one or more dosimeters through a communication means.

15. The device of claim 4, wherein said device is connected to one or more connected telepositional dosimeters through a communication means.

16. The device of claim 15, wherein said display means is a display, said processing means includes one or more processing units, said memory means is one or more storage devices, said input means is a keypad, said positioning and timing means is a GPS module, and said power means is a power supply, and where said connected telepositional dosimeters further comprise an outer case of a portable dimension, an operational mode status, a software means, one or more communication means, a display means, a processing means, a memory means, an input means, a positioning and timing means, a notification means, and a power means.

17. The device of claim 4, further comprising an alarm notification means include notification from said device by one or more of visual, audio, vibration technology, or non-indication operable in relation to one or more predetermined alarm ranges.

18. The device of claim 17, wherein said local communication means is a RS-232 connection.

19. The device of claim 18, wherein said RS-232 is in communication with a remotely connected computer.

20. The device of claim 17, wherein said software comprises analytical means to collect data and generate a complete data set.

21. The device of claim 20, wherein said device is capable of communication of said complete data set to a remotely connected computer or network device.

22. The device of claim 21, wherein said device communicates in a predetermined manner in relation to one or more predetermined communication settings.

23. A radiation measurement system for measuring and detecting radiation at one or more target areas comprising one or more software-centric data centers each having data center software, one or more communication means providing communication linkage between said one or more data centers and one or more processor-controlled telepositional dosimeters (TPDs) of said system, whereby each TPD further comprises a processing means instructively coupled to one or more of a software means, one or more communication means, a display means, a memory means, an input means, a positioning and timing means, a notification means, a power means, and an operational mode status, wherein said radiation includes alpha radiation, beta radiation, gamma radiation, x-ray radiation, neutron emissions, and related dosimetry-types of radiation and particle detection of radiated particles and said one or more TPD is portable.

24. The system of claim 23, wherein said operation mode status comprises one or more modes of monitoring, searching, security, and timer, and further comprises an alarm notification means.

25. The system of claim 24, further comprising a plurality of TPDs and at least one software-centric data center, wherein said communication means includes one or more wireless communication technologies capable of communication in real time, continuously, intermittently or in a predetermined manner.

26. The system of claim 25, wherein said display means is a display, said processing means includes one or more processing units, said memory means is one or more storage devices, said input means is a keypad, said positioning and timing means is a GPS module, and said power means is a power supply.

27. The system of claim 25, wherein said display means is a display screen of less than four diagonal inches, said processing means includes at least one central processing unit controlling communications of said device, said memory means is software-based, and said positioning and timing means is an active GPS module.

28. The system of claim 27, wherein said wireless communication is in one of TCP/IP, UDP/IP across a GSM.GPRS or CDMA based network.

29. The system of claim 27, wherein said alarm notification means include notification from said device by one or more of visual, audio, vibration technology, or non-indication.

30. The system of claim 29, wherein said alarm notification further includes communication of notification to a remotely connected user or device.

31. The system of claim 25, wherein said system is connected to one or more remote users.

32. The system of claim 31, wherein said one or more users are one or more remotely connected devices having a data storage means, a processing means and display means, in communication with one or more of said plurality of TPDs.

33. The system of claim 32, wherein said remotely connected devices is one or more computers having data center software.

34. The system of claim 25, wherein for each of said plurality of TPDs, said display means is a display, said processing means includes one or more processing units coupled with circuitry to provide instructions, said memory means is one or more storage devices, said input means is a keypad, said positioning and timing means is a GPS module, and said power means is a power supply, and where said connected telepositional dosimeters further comprise an outer case of a portable dimension, an operational mode status, a software means, one or more communication means, a display means, a processing means, a memory means, an input means, a positioning and timing means, a notification means, and a power means.

35. The system of claim 25, further comprising a plurality of alarm notification means include notification from said device by one or more of visual, audio, vibration technology, or non-indication operable in relation to one or more predetermined alarm ranges.

36. The system of claim 25, wherein said local communication means is a RS-232 connection.

37. The system of claim 36, wherein said RS-232 is in communication with a locally connected computer.

38. The system of claim 25, wherein said software comprises analytical means to collect data and generate a complete data set from information received from said plurality of TPDs.

39. The system of claim 38, wherein said software comprises analytical means to collect data and generate a complete data set from information received from a database of historical information.

40. The system of claim 25 further comprising a means for display a complete data set to a user.

41. The system of claim 40, wherein said user is a remote user.

42. The system of claim 25, wherein said plurality of TPDs each communicate in a predetermined manner in relation to one or more predetermined communication settings.

43. The system of claim 42, wherein said communication settings are predetermined in relation to said communication means being one or more radiofrequency (RF), microwave, infrared, satellite, WiMax, Wi-Fi, Bluetooth, ZigBee, wireless RS-232, wireless Universal Serial Bus (USB), Ultra Wide Band (UWB), or mobile wireless technologies (e.g., GSM/GPRS, CDMA, 3G, etc.).

44. The system of claim 43 wherein said communication means uses a communication protocol such as TCP/IP, UDP/IP or other protocol.

45. The system of claim 44, wherein said system provides a complete data set to one or more users comprising information including measurement results, status, geographic, positional, timing, and measured information.

46. A computer program product stored on a computer usable medium comprising:
computer readable program means for causing a computer to analyze radiation measurement data from a radiation measurement means of one or more telepositional dosimeters and communicate a complete data set to one or more remote users; the computer program product including program instructions for collecting, analyzing and transmitting data comprising:
collecting radiation measurement data,
collecting operation mode status data,
collecting positioning and timing data,
combining collected data,
storing combined collected data, and
transmitting stored combined collected data as a complete data set to one or more remote users.

47. The product of claim 46 wherein said data includes one or more of dose rate, dosage rate, geopositional data, geospatial data, operational status information of relevant TPDs, analyzed data, calculated data.

48. The product of claim 47 wherein said product is operable in one or more operative modes.

49. An article comprising: a machine-readable storage medium having a plurality of machine accessible instructions, which if executed by a machine, causes the machine to perform operations comprising:
collecting radiation measurement data,
collecting operation mode status data,
collecting positioning and timing data,
combining collected data,
storing combined collected data, and
transmitting stored combined collected data as a complete data set to one or more remote users,
wherein said article is capable of communication with one or more connected devices in communication therewith.

50. The article of claim 49, wherein said step is capable of being performed by a telepositional dosimeter (TPD) in communication with one or more other telepositional dosimeters and one or more remote users having datacenter software.

51. The article of claim 50, wherein each TPD is of a dimension capable of being portable.

52. The article of claim 51, wherein said TPD further comprises a processor having logic means for instructing and controlling an operation mode status comprising one or more modes of monitoring, searching, security, and timer, wherein each mode further comprises an alarm notification means, and for instructing and controlling one or more of a software means, one or more communication means, a display means, a memory means, an input means, a positioning and timing means, a local communication means and a notification means.

53. The article of claim 52, wherein said software means performs said steps of machine accessible instructions.

54. The article of claim 53, wherein said TPD is mobile.

55. A processor-controlled telepositional dosimetry machine couplable to a network having one or more of a display, a processor having logic, a memory coupled to said processor, a storage device in communication with said processor, an input device coupled with said processor, a positioning and timing module capable of providing location and time data in relation to real time radiation collection activities, a power supply providing power to at least said processor, operational mode status switching and indicator, TPD software, at least one networked communication pathway, and an alarm in communication with said operational mode status switching providing notification in response to a predetermined dose rate threshold.

56. The machine of claim 55, wherein said processor provides instructions across a network of circuitry and a complete data set is generated by said software in response to dose rate, dosage rate, geopositional data, geospatial data, operational status information of relevant TPDs, analyzed data, or calculated data obtained at a target area by said machine.

57. The machine of claim 56, wherein said software provide machine readable instructions to collect operation mode status data, collect positioning and timing data, combine collected data, store combined collected data, and transmit stored combined collected data as a complete data set to one or more remote users, wherein said machine is capable of communication with one or more connected devices in communication therewith across a communication pathway.

58. The machine of claim 57 wherein said communication pathway is one or more of radiofrequency (RF), microwave, infrared, satellite, WiMax, Wi-Fi, Bluetooth, ZigBee, wireless RS-232, wireless Universal Serial Bus (USB), Ultra Wide Band (UWB), or mobile wireless technologies (e.g., GSM/GPRS, CDMA, 3G, etc.).

59. The machine of claim 58 powered by said power supply to create and generate a complete data set to a remote user for visual display at a remote location in real time.

60. A portable telepositional dosimeter (TPD) in communication with one or more remote networked devices through one or more communication pathways, wherein said TPD provides a complete data set of information across said one or more communication pathways to said one or more remote networked devices for collection at a remote networked storage database, wherein said TPD comprises processor-controlled logic means for instructing each coupled therewith including a display, a memory, a storage device, an input device, a positioning and timing module, an operational mode status switch, an alarm and TPD software, wherein said operational mode status switch comprises one or more modes of monitoring, searching security, and timer, wherein each mode is operable to activate or deactivate said alarm.

61. A dosimeter of claim 60 further in communication with one or more TPDs.

62. A dosimeter of claim 60 further comprising a remote networked computer system in communication via a communication pathway with a plurality of dosimeters.

63. A dosimeter of claim 60, wherein said TPD is wearable.

64. A dosimeter of claim 60, wherein said TPD is battery operated.
